(19) United States
(12) Patent Application Publication
(10) Pub. No.: US 2007/0180671 A1
(43) Pub. Date: Aug. 9, 2007

(54) Machine for forming a pattern on a nonwoven and process for manufacturing a sleeve for this machine

(76) Inventor: Frederic Noelle, Saint Nazaire Les Eymes (FR)

Correspondence Address: PEARNE & GORDON LLP, 1801 EAST 9TH STREET, SUITE 1200, CLEVELAND, OH, 44114-3108, US

(21) Appl. No.: 10/572,143

(22) PCT Filed: Sep. 14, 2004
(86) PCT No.: PCT/FR04/02327

§ 371 Date: Sep. 29, 2006

(30) Foreign Application Priority Data
Sep. 18, 2003 (FR) 0310974

(51) Int. Cl. D04H 1/46; D04H 5/02; B32B 5/14

(52) U.S. Cl. 28/104; 428/171

(57) ABSTRACT

In this machine for forming patterns on a nonwoven, which includes a rotary drum (29) surrounded by a sleeve (30), the sleeve is coated with a nickel or copper coating.

The present invention relates to machines for forming patterns on a nonwoven and to sleeves and processes for manufacturing a sleeve for machines of this kind.

WO 01/25522 A1, describes a machine for forming patterns on a nonwoven which includes a rotary drum the interior of which communicates with a vacuum source. The rotary drum is provided with slits on the lateral surface. It is surrounded, apart from a perforated covering, by an apertured sleeve having a succession of patterns in the form of bumps and hollows. The apertured sleeve is made of a bronze cloth. By sending water jets onto a nonwoven passing over the sleeve, patterns are created thereon.

It turns out that the bronze cloth deforms, slackens and breaks up too rapidly, the bronze becoming softer and softer. Therefore the cloth has to be replaced too often, which is a drawback.

The invention remedies this by a technical solution of greater longevity.

One subject of the invention is a machine for forming patterns on a nonwoven that includes a drum mounted so as to rotate, the interior of which communicates with a vacuum source, which drum is provided with slits on the lateral surface and is surrounded by an apertured sleeve made of a bronze, brass, stainless steel or copper cloth having a succession of patterns in the form of bumps and hollows. According to the invention, the sleeve is coated with a nickel or copper coating obtained in particular by electrolysis and preferably having a thickness of 50 μm to 500 μm.

It has now been understood that the cloth used hitherto was too flexible and that the yarns of the cloth were not sufficiently in contact with one another so that the fibres of the nonwoven were caught in the spaces between the yarns of the cloth, with deformation, slackening and twisting of the latter. By coating the sleeve with a coating, preferably a nickel coating, as provided according to the invention, these spaces are eliminated as are the fibre catching points, since now the yarns of the cloth are bonded together at their intersections by the nickel or copper coating. This guarantees the longevity of the cloth, which is no longer now subjected to the pulling forces generated by the fibres catching thereon. The strength of the sleeve is improved. However, the permeability of the sleeve is preserved.

The term “cloth” is understood to mean any woven or knit having meshes.

Preferably, the sleeve is made of nickel-coated bronze.

Preferably, the sleeve has an openness of 5 to 50%, the openness being defined by the ratio of the area of the apertures of the sleeve to the total area of the sleeve.

Preferably, the rotary drum is surrounded by a perforated covering and this perforated covering itself is surrounded by the apertured sleeve according to the invention. The perforated covering may have perforations with a diameter of 0.5 to 5 mm and the distance between two consecutive perforations may be between 1.5 and 12 mm. This covering may be made of steel, bronze or plastic.

Another subject of the invention is a process for manufacturing the apertured sleeve. This process consists in embossing a bronze, brass, stainless steel or copper cloth with patterns in the form of bumps and hollows, in forming the cloth into a sleeve preform by welding two opposed edges, in mounting the preform on a rotary support cylinder and immersing it in a nickel or copper electroplating bath until a nickel or copper coating has been electroplated thereon and in removing the apertured sleeve from the bath. The preform, while it is immersed in the bath, is rotated on the support in order to obtain a nickel or copper electroplated coating that is as uniform as possible. It would not be possible to deposit nickel directly on the bronze cloth because the subsequent shaping of the bronze cloth into a sleeve would break the thin nickel or copper coating.

The final subject of the invention is an apertured sleeve made of a bronze, brass, stainless steel or copper cloth forming non-perforating patterns in the form of bumps and hollows, characterized in that the cloth 30 is coated with a nickel or copper coating.

Embossing the sleeve gives it non-perforating patterns such that the difference in level between the highest point and the lowest point of a pattern, measured along the thickness of the wall, is between 0.5 mm and 5 mm, in particular between 1 and 5 mm. The sleeve of circular cross section has in particular a wall thickness of between 1.5 and 7 mm.

EP-0 215 684 describes a machine for forming a perforated nonwoven.

The appended drawings are given merely by way of example:

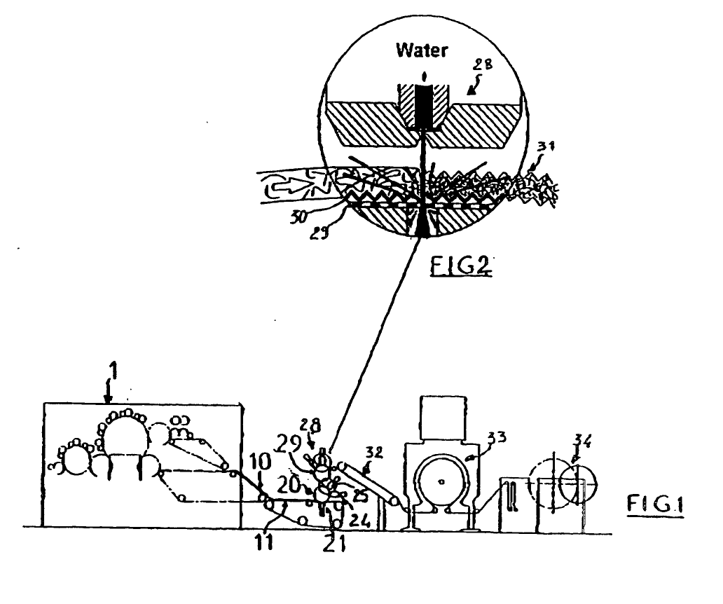

FIG. 1 illustrates a nonwoven production line incorporating a machine according to the invention; and

FIG. 2 is a partial sectional view illustrating the machine according to the invention.

FIGS. 1 and 2 appended hereto show a production line for producing a nonwoven in accordance with the process of the invention, this production line essentially consisting of an assembly, denoted by the general reference (1), for producing, by the carding or lapping of continuous filaments or by any other similar technique, a web that may be formed from continuous fibres or filaments or from a mixture of continuous fibres and filaments made of synthetic, artificial or natural material, especially polyester, polypropylene, viscose, polylactic acid, cotton, polyvinyl alcohol, wood fibres, and either synthetic fibres or natural fibres.

After leaving the zone for forming the web (10), the latter is transferred onto a porous conveyor belt (11) formed for example by an endless cloth made of synthetic, especially polyester, monofilaments, which cloth has a porosity of between 20 and 60%, that is to say a ratio of solid areas to empty areas of between 20 and 60%, preferably around 30%.

This porous support (11) is associated, in a manner similar to the teachings of FR-A-2 730 246, with a water-jet treatment assembly, making it possible, on the one hand, to compress and wet the web (10) formed and, on the other hand, to subject this web to the action of water-jet rails. Such an assembly essentially comprises a rotary cylindrical drum denoted by the general reference (20) which bears against the surface of the conveyor belt (11).

A first water-jet rail (21) is placed beneath the support (11) and enables the web (10) to be prewetted. This rail is placed at a distance of between 70 and 100 mm from the porous support (11) and forms a curtain of water for wetting the compressed web and for introducing a slight first entanglement of the web. cylinder with a honeycomb structure (not shown in the appended figures), which is covered with a metal foil (22) having micro perforations that are randomly distributed on its surface or by a woven surface. This rotary cylinder surrounds a second cylindrical drum (23) which is coaxial, stationary, hollow and connected to a partial vacuum source in order to form a suction box, suction being exerted through slits (26) located facing the zone of action of the water jets.

The web (10), after being prewetted by means of the rail (21), and as is apparent from the figures, is subjected to the action of pressurized water jets (27) is coming from two conventional rails (24, 25).

Optionally, it would be conceivable to have only a single rail (24) or to have more than two successive rails associated with the drum (20).

These rails (21, 24, 25) are formed from contiguous injectors placed at predetermined distances apart from one another.

The drum has, facing each rail (21, 24, 25), a alit (26) that extends over the entire length of a generatrix and has a width generally between 5 mm and 30 mm, the water from the jets (27) being recovered through said slit.

After being bonded on the assembly (20), the web is subjected to the action of a second assembly (28) made in accordance with the invention, the general structure of which is shown more clearly in FIG. 2. This assembly (26) consists of a rotary suction drum (29), also formed by a cylindrical honeycomb structure (not shown in the figure), which supports a perforated cylindrical covering (29). By way of indication, the perforations in this covering (29) may have a diameter of 3 mm, the distance between two consecutive orifices being 4 mm and the orifices being offset from one row to the next.

According to the invention, the perforated covering (29) is covered with a sleeve-shaped apertured sleeve (30) having a succession of bumps and hollows.

This apertured sleeve (30) is formed by an open cloth made of bronze yarns, having an openness of between 10% and 50%, said cloth having been embossed in order to comprise a succession of non-perforating bumps and hollows. These bumps and hollows may have a regular structure, for example in the form of chevrons, or a configuration forming irregular patterns. The cloth (30) is coated with a nickel coating 50 to 500 microns in thickness obtained by electroplating in the following manner:

the perforated covering (or cylinder) (29) covered with its apertured sleeve (30) is mounted on a rotary support. The sleeve (30) is partly immersed in an electrolyte in a galvanic plating bath. A nickel electrode, immersed in the electrolyte, is connected to the cathode of a DC generator. The sleeve (30) is itself connected to the anode of the same generator via a rotating commutator, which ensures that the current passes while the sleeve (30) is rotating. The nickel from the cathode migrates into the electrolyte and is deposited on the sleeve connected to the anode. A motor rotates the sleeve (30) mounted on its support in order to obtain a fine uniform coating over the entire surface of the sleeve (30).

As is more apparent from FIG. 2, the prebonded web, as it passes through this treatment zone (28), is restructured by action of one or more series of jets, coming from conventional water injectors, in the present case two injectors. Under the action of these jets, the web closely conforms to the configuration of the bumps and hollows of the apertured sleeve (30). After treatment, the treated web (31) is fed onto a conveyor (32), where the water is removed, for example by means of a suction box placed beneath the conveyor (32), and the web is then dried by passing over a through-air drying cylinder (33) having a temperature of around 150° C. before being collected in the form of a reel (34).

1-11. (canceled)

12. An apertured sleeve made of a bronze, brass or copper cloth, arranged in a non-perforating pattern in the form of bumps and hollows, said cloth being coated with a nickel or copper coating.

13. A sleeve according to claim 12, wherein said nickel or copper coating is an electroplated coating.

14. A sleeve according to claim 13, wherein the thickness of the nickel or copper coating is between from about 50 microns and about 500 microns.

15. A sleeve according to claim 12, wherein the sleeve has an openness of from about 5% to about 50%.

16. A sleeve according to claim 12, wherein said sleeve has a wall thickness and the difference in level or height between the highest point and the lowest point of a pattern, measured along the thickness of the wall thickness, is between from about 0.5 mm to about 5 mm.

17. A sleeve according to claim 16, wherein the difference in level or height is from about 1 mm to about 5 mm.

18. A sleeve according to claim 12, wherein said sleeve has a wall thickness of from about 1.5 mm to about 7 mm.

19. A sleeve according to claim 12, wherein said cloth is a nonwoven knitted construction having meshes and said nickel or copper coating reduces the sizes of said meshes.

20. A sleeve according to claim 19, wherein said cloth has a flexibility and said nickel or copper coating reduces the flexibility of said cloth and any tendency of said meshes to open upon flexing of said cloth.

21. A machine for forming patterns on a nonwoven, said machine including a drum mounted to rotate and having an interior communicating with a vacuum source, the drum including a lateral surface provided with slits therethrough and surrounded by an apertured sleeve made of a bronze, brass, stainless steel or copper cloth, said sleeve forming non-perforating patterns in the form of bumps and hollows and being coated with a nickel or copper coating.

22. A machine according to claim 21, wherein said drum is surrounded by a perforated covering which, in turn, is surrounded by said apertured sleeve.

23. A machine according to claim 22, wherein said perforated covering includes perforations having a diameter of 1.5 mm and the distance between adjacent perforations is between 2 mm and 6 mm.

24. A process for manufacturing an apertured sleeve having patterns in the form of bumps or hollows embossed on a bronze, brass, stainless steel or copper cloth, comprising the steps of forming said cloth into a sleeve preform by welding together two opposed edges of the cloth, mounting said sleeve preform on a rotary support cylinder and immersing the sleeve preform in a nickel or copper electroplating bath to electroplate a nickel or copper coating thereon, and withdrawing said sleeve preform with said nickel or copper electroplated coating thereon from said bath to provide said apertured sleeve.
